(19) United States
(12) Patent Application Publication
(10) Pub. No.: US 2023/0028277 A1
(43) Pub. Date: Jan. 26, 2023

(54) OPENING AND CLOSING MECHANISM FOR VEHICLE BODY COVER

(71) Applicant: TAKEUCHI MFG. CO., LTD., Nagano (JP)

(72) Inventor: Shingo SHIRAISHI, Nagano (JP)

(21) Appl. No.: 17/726,676

(22) Filed: Apr. 22, 2022

(30) Foreign Application Priority Data
Jul. 21, 2021 (JP) 2021-120766

(51) Int. Cl. E05C 3/14; E02F 9/08

(52) U.S. Cl. CPC E05C 3/14; E02F 9/0891

(57) ABSTRACT

An opening and closing mechanism for a vehicle body cover which is attached to and detached from a vehicle body of a working vehicle in a separable manner includes a latching portion configured to latch an upper portion of the vehicle body cover to the vehicle body, and a lock portion configured to lock a lower portion of the vehicle body cover to the vehicle body, wherein the lock portion includes a striker provided at the vehicle body cover, a hook provided at the vehicle body, the striker being engageable with and disengageable from the hook, and a lock release portion configured to release a state of the striker being engaged with and locked by the hook, and wherein the lock release portion is arranged at a position which, when directly facing an opening portion provided at the vehicle body, is not viewable inside a field of view of the opening portion and which is graspable by a worker putting a worker's hand inside from the opening portion and stretching worker's fingers from inside the field of view of the opening portion to outside the field of view of the opening portion.

### CROSS-REFERENCE TO RELATED APPLICATION

This application is based upon and claims the benefit of priority of the prior Japanese Patent Application No. P2021-120766, filed on Jul. 21, 2021, and the entire contents of which are incorporated herein by reference.

### TECHNICAL FIELD

The present invention relates to an opening and closing mechanism for a vehicle body cover of a working vehicle.

### BACKGROUND ART

Heretofore, as a working vehicle configured to include a travel unit including, for example, crawlers or tires, a vehicle body provided on the travel unit, a work unit provided at a front portion of the vehicle body and configured to be hydraulically driven, and an equipment room provided at a rear portion of the vehicle body and having various pieces of equipment, such as a drive source and a battery, arranged therein, there have been known, for example, an excavator and a crawler loader (track loader).

In the above-mentioned working vehicle, since, for example, maintenance work for equipment arranged in the equipment room may be performed, a configuration in which an opening portion for work and a cover (vehicle body cover) for opening and closing the opening portion are provided at the equipment room has become usual (see PTL 1: JP-A-2009-203729).

### SUMMARY OF INVENTION

### Technical Problem

Here, a conventional vehicle body cover such as that taken as an example in PTL 1 is fixed to the vehicle body in such a way as to be openable and closable with use of, for example, a hinge, and is thus configured to be unlikely to be easily detached (separated) from the vehicle body. Therefore, depending on the content of maintenance, work may be difficult to perform. Additionally, there is a structure in which a keyhole (release portion) of a lock portion for use in locking the vehicle body cover to the vehicle body is externally viewable, so that, from the viewpoint that access by a third party is easy, there is room for improvement for security reasons.

### Solution to Problem

In response to the above issue, one or more aspects of the present invention are directed to providing an opening and closing mechanism for a vehicle body cover capable of implementing a configuration attachable to and detachable from a vehicle body in a separable manner, attaining an improvement in workability of maintenance work on equipment inside the vehicle body, and attaining an improvement in security by making access to a lock portion for locking the vehicle body cover to the vehicle body unlikely to be easily performed.

In view of the above, the following embodiments are described below.

An opening and closing mechanism for a vehicle body cover which is attached to and detached from a vehicle body of a working vehicle in a separable manner includes a latching portion configured to latch an upper portion of the vehicle body cover to the vehicle body, and a lock portion configured to lock a lower portion of the vehicle body cover to the vehicle body, wherein the lock portion includes a striker provided at the vehicle body cover, a hook provided at the vehicle body, the striker being engageable with and disengageable from the hook, and a lock release portion configured to release a state of the striker being engaged with and locked by the hook, and wherein the lock release portion is arranged at a position which, when directly facing an opening portion provided at the vehicle body, is not viewable inside a field of view of the opening portion and which is graspable by a worker putting a worker's hand inside from the opening portion and stretching worker's fingers from inside the field of view of the opening portion to outside the field of view of the opening portion.

### Advantageous Effects of Invention

According to the present invention, a configuration capable of attaching and detaching a vehicle body cover to and from a vehicle body in a separable manner can be implemented, and an improvement in workability of maintenance work on equipment inside the vehicle body can be attained. Moreover, an improvement in security can be attained by making access to a lock portion for locking the vehicle body cover to the vehicle body unlikely to be easily performed. In this way, compatible solutions can be provided with respect to conflicting issues, i.e., making separation work for the vehicle body cover easy and improving security.

### BRIEF DESCRIPTION OF DRAWINGS

FIG. 1 is a perspective view illustrating an example of a working vehicle equipped with an opening and closing mechanism for a vehicle body cover according to an embodiment of the present invention.

FIG. 2 is an explanatory diagram illustrating an opening and closing state of the vehicle body cover of the working vehicle illustrated in FIG. 1.

FIG. 3 is a perspective view illustrating an example of the vehicle body cover of the working vehicle illustrated in FIG. 1.

FIG. 4 is a sectional side view illustrating an example of a vehicle body of the working vehicle illustrated in FIG. 1.

FIG. 5 is an enlarged view illustrating an example of a latching portion of the opening and closing mechanism for the vehicle body cover according to the embodiment.

FIG. 6 is an enlarged view illustrating an example of a lock portion of the opening and closing mechanism for the vehicle body cover according to the embodiment.

FIG. 7 is a back view of the working vehicle illustrated in FIG. 1 and is a view directly facing an opening portion of the opening and closing mechanism for the vehicle body cover according to the embodiment.

FIG. 8 is an exploded perspective view illustrating an example of an internal cover of the opening and closing mechanism for the vehicle body cover according to the embodiment.

FIG. 9 is a perspective view illustrating an example of a tying-down attachment point of the working vehicle illustrated in FIG. 1.

FIG. 10 is a perspective view illustrating an example of a positional deviation prevention portion of the opening and closing mechanism for the vehicle body cover according to the embodiment.

FIG. 11 is an enlarged view illustrating an example of the positional deviation prevention portion of the opening and closing mechanism for the vehicle body cover according to the embodiment.

### DESCRIPTION OF EMBODIMENTS

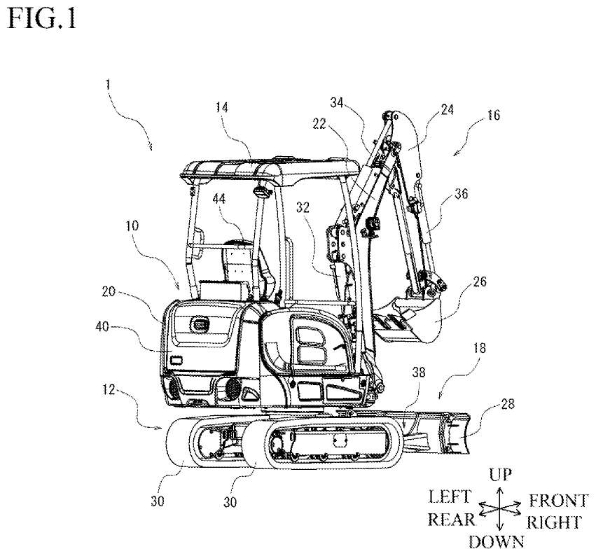

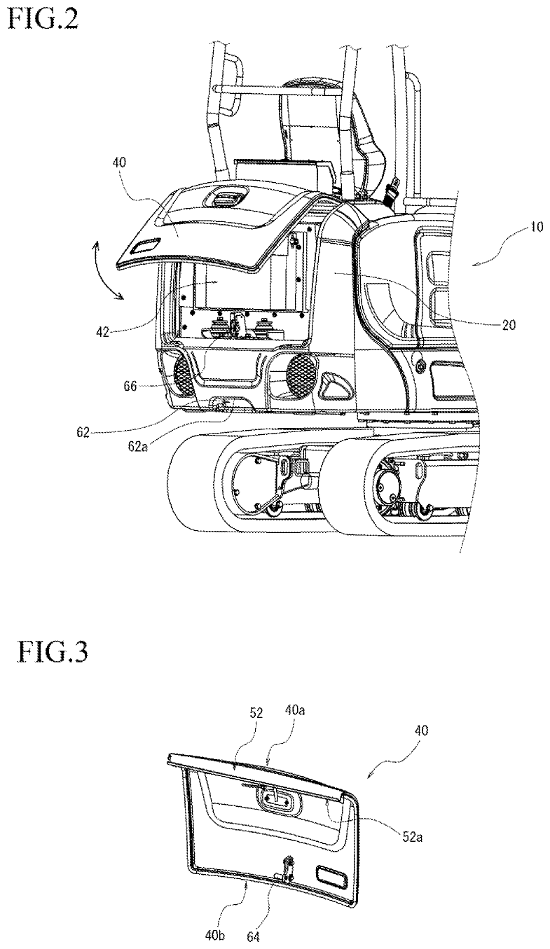

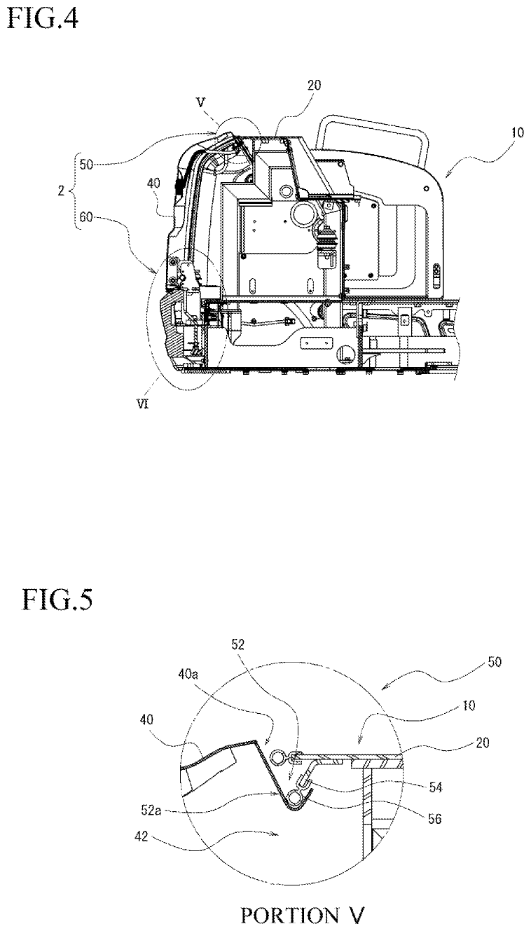

An embodiment of the present invention will be described in detail below with reference to the drawings. FIG. 1 is a schematic diagram (a perspective view as viewed from a rear right side) illustrating an example of a working vehicle 1 equipped with an opening and closing mechanism 2 for a vehicle body cover 40 according to the present embodiment. Moreover, FIG. 2 is an explanatory diagram illustrating an opening and closing state of the vehicle body cover 40 of the working vehicle 1 illustrated in FIG. 1. Moreover, FIG. 3 is a schematic diagram (a perspective view as viewed from a front upper side) of a front side (a side facing a vehicle body opening portion 42) of the vehicle body cover 40. Moreover, FIG. 4 is a schematic diagram (a sectional side view) of a vehicle body 10. Furthermore, for the purpose of illustration, up and down, left and right, and front and rear directions may be represented by arrows in the figures. Moreover, in all of the figures for use in describing the embodiment, members having the same functions are assigned the respective same reference characters, and the repetitive description thereof may be omitted.

First, the entire configuration of the working vehicle 1 is described. While, here, an excavator which travels with crawlers driven by, for example, a hydraulic motor is described as an example, the present embodiment is not limited to this.

The working vehicle 1 is configured to include, as illustrated in FIG. 1, a travel unit 12, which includes a pair of right and left crawlers 30, the vehicle body 10 provided in a swivelable manner on the travel unit 12, and a work unit (for example, a shovel unit 16 or a blade unit 18) provided to be supported by, for example, the vehicle body 10. Moreover, the vehicle body 10 is provided with, at a central portion thereof, a control room 14, in which a worker (operator) sits to operate, for example, the travel unit 12 and the work units 16 and 18, and, at a rear portion thereof, an equipment room 20, in which, for example, a drive source and a battery are mounted. Furthermore, examples of the drive source, which drives the travel unit 12 and the work units 16 and 18, include an engine (internal combustion) and an electric motor driven by battery power supply (each not illustrated).

First, the control room 14 is configured to include, for example, a seat 44, on which the worker rides and sits, various operating levers and operating switches for operating actuations of, for example, the travel unit 12, and a display unit, which displays various pieces of vehicle information (each not illustrated). The control room 14 according to the present embodiment is an open-type canopy. However, the control room 14 is not limited to this, but can be a closed-type cabin (not illustrated).

Next, the work units are described. First, the shovel unit 16 includes a boom 22 and an arm 24, which are pivotally connected to a front portion of the vehicle body 10 via a boom bracket (not illustrated) in such a way as to be swingable up and down. Furthermore, the shovel unit 16 can have a configuration which does not include the boom bracket. Additionally, the shovel unit 16 includes an attachment (for example, a bucket) 26, which is pivotally connected to a forefront portion of the arm 24 in such a way as to be swingable up and down. The boom 22, the arm 24, and the attachment 26 are driven by hydraulic cylinders 32, 34, and 36, respectively.

On the other hand, the blade unit 18 includes a blade 28, which is pivotally connected to a front portion of the travel unit 12 in such a way as to be swingable up and down. The blade 28 is driven by a hydraulic cylinder 38.

Mechanisms used to drive the above-mentioned hydraulic cylinders 32, 34, 36, and 38 include, for example, hydraulic pumps and control valves (not illustrated) which are driven by drive sources (for example, an engine and an electric motor). Furthermore, the other mechanisms (for example, a drive mechanism and a control mechanism) for use in travel motion and work in the working vehicle 1 are similar to those in a known working vehicle (here, an excavator), and, therefore, the detailed description thereof is omitted.

Next, the opening and closing mechanism 2 for the vehicle body cover 40 according to the present embodiment is described in detail. Equipment including, for example, the above-mentioned drive sources (for example, an engine and an electric motor), battery, hydraulic pumps, and control valves is arranged dispersedly as appropriate, for example, inside the equipment room 20 and under the floor of the vehicle body 10. In the present embodiment, inside the equipment room 20, a battery and a peripheral unit are mainly arranged. However, not only these pieces of equipment are arranged therein. Moreover, the equipment room 20 includes the vehicle body opening portion 42, which is used to perform, for example, maintenance work for such equipment, and the vehicle body cover 40, which opens and closes the vehicle body opening portion 42. As an example, the equipment room 20 (a structural member such as an outside wall) and the vehicle body cover 40 are configured with use of metallic materials. However, not only this configuration is employed, but, for example, the vehicle body cover 40 can be configured with use of a resin material.

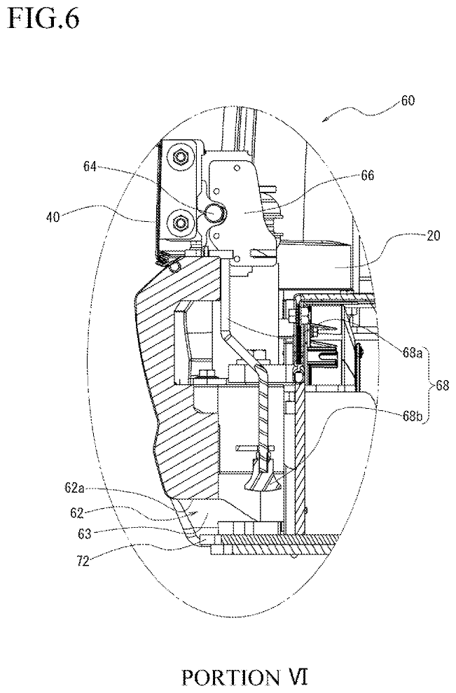

A specific configuration of the opening and closing mechanism 2 for the vehicle body cover 40 includes, as illustrated in FIG. 4, a latching portion 50, which latches an upper portion 40a of the vehicle body cover 40 to the vehicle body 10, and a lock portion 60, which locks a lower portion 40b of the vehicle body cover 40 to the vehicle body 10. Here, FIG. 5 is an enlarged view of the latching portion 50 (an enlarged view of a portion V in FIG. 4). Moreover, FIG. 6 is an enlarged view of the lock portion 60 (an enlarged view of a portion VI in FIG. 4).

First, the lock portion 60 includes a striker 64, which is provided at the vehicle body cover 40, a hook 66, which is provided at the vehicle body 10 and which the striker 64 engages with and disengages from, and a lock release lever 68, which serves as a lock release portion to release the state of the striker 64 being engaged with and locked by the hook 66. Furthermore, the hook 66 and the striker 64 can be configured with use of a known mechanism, and a locked state occurs when the striker 64 engages with a predetermined portion included in the hook 66. On the other hand, a mechanism in which the locked state is released by operating (in the present embodiment, pulling) the lock release lever 68, which is coupled to a release portion of the hook 66, is employed. Furthermore, the lock portion 60 does not include a key for release.

As an example, the lock release lever 68 is of the link type and is configured to include a rod 68a (including a configuration having a plurality of elements coupled) and a grip 68b, which is provided at an end portion (lower end portion) of the rod 68a. The worker performs a release operation by grasping and pulling the grip 68b to draw down the rod 68a, which acts on the release portion of the hook 66. This enables releasing a state in which the striker 64 engages with the hook 66, i.e., a locked state. Furthermore, as a modification example, the lock release portion 68 can be of the wire type, i.e., can have a configuration (not illustrated) in which, instead of the rod 68a, a wire rope is used to operate the release portion of the hook 66.

Additionally, as another modification example, the lock release lever 68 can be of the electrical drive type, i.e., can have a configuration (not illustrated) in which an electrical drive mechanism including, for example, a solenoid is used to operate the release portion of the hook 66, thus releasing the locked state between the striker 64 and the hook 66. In that case, a configuration for causing the electrical drive mechanism to operate via a remote controller, which performs wireless communication, can be appropriately used in combination with the lock release lever 68.

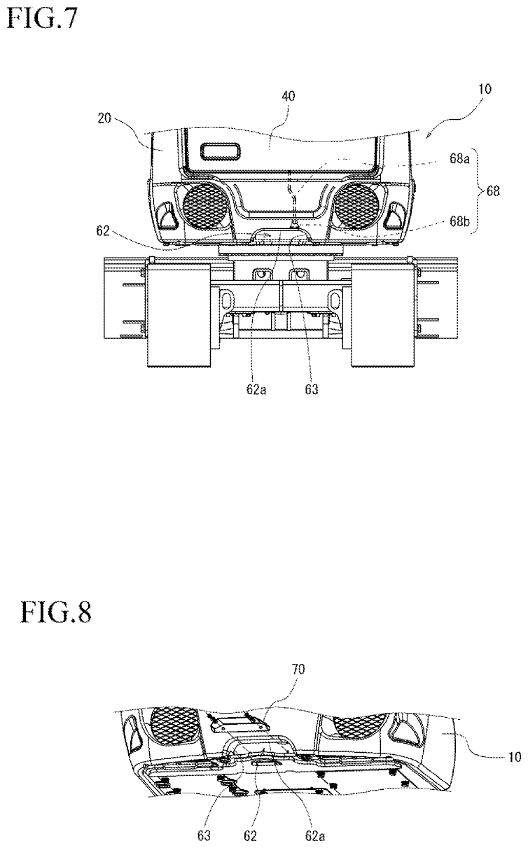

Here, the lock release lever 68 according to the present embodiment is provided, as illustrated in FIG. 7, at a position in which, when directly facing an opening portion 62, the lock release lever 68 is not viewable inside an opening field of view (inside an opening region), i.e., is arranged such that the grip 68b at an end portion (for example, a lower end portion) does not appear inside the opening field of view (inside the opening region). More specifically, in the lock release lever 68, the grip 68b is arranged at a position which the worker is able to grasp by putting the worker's hand inside from the opening portion 62, which is provided on a lower side of the rear portion of the vehicle body 10, and then, in a position deeper than a position where the inner circumference surface ends, stretching the worker's fingers from inside the opening field of view (inside the opening region) to outside the opening field of view (i.e., from inside the opening region to a surrounding outside region). Accordingly, when the worker performs an operation for lock release, an upper surface 62a (what is called a ceiling surface) in the inner circumference of the opening portion 62 functions as a supporting surface on which the worker puts the worker's palm for applying force when pulling the grip 68b. The opening portion 62 is defined by the upper surface of a tying-down attachment point 72 and an opening portion defining surface 63, which defines a part of the opening portion 62 formed on the lower side of the rear portion of the vehicle body 10, and the opening portion 62 communicates with the equipment room 20 and the vehicle body opening portion 42.

According to the above-described configuration, a configuration in which the lock portion 60, which locks the vehicle body cover 40 to the vehicle body 10, is not viewable from the outside can be implemented. Accordingly, this enables attaining an improvement in security by making access to the lock portion 60 unlikely to be easily performed. Particularly, in a case where the control room 14 is an open-type canopy, for a security reason, it is impossible to set, in an exposed state inside the control room 14, for example, a lever which is used to open and close the vehicle body cover 40. Therefore, the configuration of the lock portion 60 according to the present embodiment is even more effective.

Moreover, the lock portion 60 does not have a keyhole, and thus enables an opening and closing operation which does not require locking and unlocking. Accordingly, the worker is able to very easily perform an opening and closing operation for the vehicle body cover 40. In this way, according to the opening and closing mechanism 2 for the vehicle body cover 40 in the present embodiment, a solution compatible with such conflicting issues as an improvement in security and a facilitation of an opening and closing (attaching and detaching) operation can be provided.

In addition to the above-described configuration, a configuration in which, as illustrated in FIG. 8, on the inside of the opening portion 62, an internal cover 70 which covers the inner circumference of the opening portion 62 and restricts the lock release lever 68 from being touched is fixed by, for example, volts can be employed. With this configuration, if a tool for taking off, for example, volts used to fix the internal cover 70 is not prepared, it is impossible to detach the internal cover 70 and it is impossible to access the lock release lever 68, and, therefore, it becomes possible to even more attain an improvement in security.

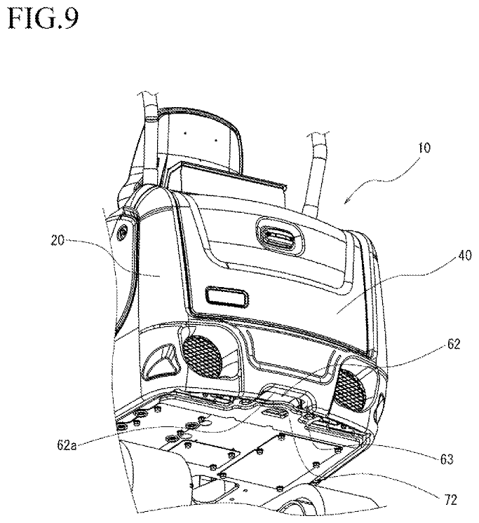

Additionally, in the present embodiment, a configuration in which, as illustrated in FIG. 9, the opening portion 62 is also additionally used as an entry port into which to enter a tying-down member (for example, a wire rope, a rope, a chain, or a fixing hook) to perform tying-down with respect to the tying-down attachment point 72 provided at the vehicle body 10 is employed. In this way, since a configuration (entry port) for the tying-down attachment point 72, which is essential for transport, is also additionally used as a configuration (opening portion 62) for the opening and closing mechanism 2 for the vehicle body cover 40, an opening portion exclusively used for the opening and closing mechanism 2 for the vehicle body cover 40 does not need to be provided, and, therefore, it becomes possible to attain simplification of both a vehicle body structure and a manufacturing process.

Next, the latching portion 50 includes a latching groove 52 having a U-shaped cross section, a V-shaped cross section, or an arc-shaped cross section, which is provided at the upper portion 40a of the vehicle body cover 40 and is open upward, and a latching projection 54, which is provided at a corresponding predetermined position of the vehicle body 10 (in the present embodiment, an upper edge portion of the vehicle body opening portion 42) and projects downward to be latched to the latching groove 52.

Specifically, the latching groove 52 has a groove shape formed to be continuous along the right-left direction of the vehicle body 10. On the other hand, the latching projection 54 has a plate shape formed to be continuous along the right-left direction of the vehicle body 10. However, the latching projection 54 is not limited to such a continuous shape, but can have an intermittent shape (for example, a plate shape or a conical shape) (not illustrated).

According to the above-described configuration, in a lock release state (a state in which the striker 64 has come off from the hook 66), the vehicle body cover 40 is able to be turned (i.e., opened and closed) with respect to the vehicle body 10 with the latching projection 54 latched to the latching groove 52 (see FIG. 2). Additionally, the worker is able to separate (i.e., detach) the vehicle body cover 40 from the vehicle body 10 (specifically, the equipment room 20) by turning the vehicle body cover 40 upward by a predetermined angle and then pulling the vehicle body cover 40 rearward (depending on angles, in some cases, up rearward or down rearward). Furthermore, in the present embodiment, to prevent the latching groove 52 and the latching projection 54, each of which is made from, for example, a metallic material, from directly coming into sliding contact with each other and thus becoming worn, a protective cap 56 which is made from a material such as rubber or elastomer and is elastically deformable is attached to, for example, a forefront portion of the latching projection 54.

In this way, the latching portion 50 does not have, for example, a hinge or hinge brace, so that it is possible to easily separate (detach) the vehicle body cover 40 from the vehicle body 10. This enables causing the vehicle body opening portion 42 of the equipment room 20 to be exposed outside with the vehicle body cover 40 separated (detached). Accordingly, a broad work space which is not blocked by the vehicle body cover 40 is able to be secured, so that, in performing maintenance work on equipment arranged inside the equipment room 20, it becomes possible to attain a marked improvement in workability. Furthermore, since the latching groove 52 in the latching portion 50 has a groove shape formed to be continuous along the right-left direction of the vehicle body 10, according to the present embodiment, an advantageous effect of discharging rainwater by using the latching groove 52 as a gutter to cause rainwater to pass through the latching groove 52 and flow to end portions thereof in the right-left direction can also be attained.

In addition to the above-described configuration, the latching portion 50 according to the present embodiment further includes a positional deviation prevention portion 80, which is provided at the vehicle body 10 and is able to come into abutting contact with an outer surface 52a of the latching groove 52 to prevent any positional deviation of the vehicle body cover 40. This enables performing stable opening and closing while preventing unintended separation from occurring in the process of turning.

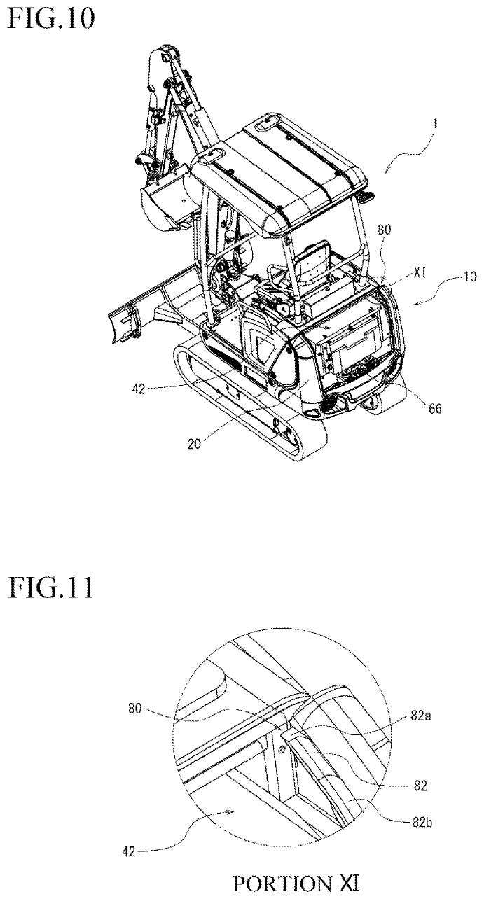

A specific configuration thereof includes a configuration in which, as illustrated in FIG. 10 (a state in which the vehicle body cover 40 has been separated (detached)) and FIG. 11 (an enlarged view of a portion XI in FIG. 10), upper end portions 82a of a pair of ribs 82b extending in the up-down direction with respect to the right-left direction of counter weights 82 provided at the vehicle body 10 are used as the positional deviation prevention portion 80. According to this configuration, extensionally providing the counter weights 82 (ribs 82b) in the up-down direction enables attaining a compactness in the horizontal direction and additionally using the upper end portions 82a thereof as the positional deviation prevention portion 80. Accordingly, a separate positional deviation prevention portion does not need to be provided, so that it becomes possible to attain simplification of both a vehicle body structure and a manufacturing process. As an example, a configuration in which, in the upper end portions 82a of the counter weights 82, a region of the vehicle body cover 40 facing the outer surface 52a of the latching groove 52 becomes able to come into abutting contact with the outer surface 52a when the vehicle body cover 40 deviates rearward is employed. Additionally, such a region is arranged at a position away from a set trajectory position of the vehicle body cover 40 by a predetermined dimension and has a curved surface shape convex outward formed in such a way as to enable smooth sliding when coming into abutting contact with the vehicle body cover 40 (outer surface 52a).

Furthermore, as a modification example of the latching portion 50, unlike the above-described configuration, a configuration in which a latching projection which projects downward is provided at an upper portion of the vehicle body cover 40, a latching groove having a U-shaped cross section, a V-shaped cross section, or an arc-shaped cross section, which is open upward, is provided at a corresponding predetermined position of the vehicle body 10 (the upper edge portion of the vehicle body opening portion 42), and the latching projection is latched to the latching groove and is thus turned can be employed (not illustrated).

As described above, according to an opening and closing mechanism for a vehicle body cover in the present embodiment, a configuration in which the vehicle body cover is able to be attached to and detached from a vehicle body in a separable manner can be implemented and an improvement in workability for maintenance work on internal equipment can be attained. Moreover, an improvement in security can be attained by making access to a lock portion for locking the vehicle body cover to the vehicle body unlikely to be easily performed.

Furthermore, the present invention is not limited to the above-described embodiment, but can be altered in various manner within a range not departing from the present invention. Particularly, while the excavator has been described as an example of a working vehicle, the working vehicle is not limited to this, and, naturally, the present invention can also be similarly applied to, for example, another type of working vehicle such as a loader or a carrier.

What is claimed is:

1. An opening and closing mechanism for a vehicle body cover which is attached to and detached from a vehicle body of a working vehicle in a separable manner, the opening and closing mechanism comprising:
a latching portion configured to latch an upper portion of the vehicle body cover to the vehicle body; and
a lock portion configured to lock a lower portion of the vehicle body cover to the vehicle body,
wherein the lock portion includes a striker provided at the vehicle body cover, a hook provided at the vehicle body, the striker being engageable with and disengageable from the hook, and a lock release portion configured to release a state of the striker being engaged with and locked by the hook, and
wherein the lock release portion is arranged at a position which, when directly facing an opening portion provided at the vehicle body, is not viewable inside a field of view of the opening portion and which is graspable by a worker putting a worker's hand inside from the opening portion and stretching worker's fingers from inside the field of view of the opening portion to outside the field of view of the opening portion.

2. The opening and closing mechanism for the vehicle body cover according to claim 1, wherein the opening portion is configured to be additionally used as an entry port into which to enter a tying-down member to perform tying-down with respect to a tying-down attachment point provided at the vehicle body.

3. The opening and closing mechanism for the vehicle body cover according to claim 1, wherein the lock portion further includes, inside the opening portion, an internal cover configured to cover an inner circumference of the opening portion and restrict the lock release lever from being touched.

4. The opening and closing mechanism for the vehicle body cover according to claim 1, wherein the latching portion includes a latching groove provided at the vehicle body cover and being open upward, and a latching projection provided at a corresponding predetermined position of the vehicle body and configured to be latched to the latching groove, and
wherein, in a state in which the latching projection has been latched to the latching groove, the vehicle body cover is configured to be opened and closed in such a way as to be able to turn with respect to the vehicle body.

5. The opening and closing mechanism for the vehicle body cover according to claim 4, wherein the latching portion further includes a positional deviation prevention portion provided at the vehicle body and being able to come into abutting contact with an outer surface of the latching groove to prevent any positional deviation of the vehicle body cover.

6. The opening and closing mechanism for the vehicle body cover according to claim 5, wherein upper end portions of counter weights provided at the vehicle body are configured to be used as the positional deviation prevention portion.

7. The opening and closing mechanism for the vehicle body cover according to claim 1, wherein the latching portion includes a latching projection provided at the upper portion of the vehicle body cover, and a latching groove provided at a corresponding predetermined position of the vehicle body and being open upward to be latched to the latching projection, and
wherein, in a state in which the latching projection has been latched to the latching groove, the vehicle body cover is configured to be opened and closed in such a way as to be able to turn with respect to the vehicle body.
